(19) United States
(12) Patent Application Publication
(10) Pub. No.: US 2022/0349630 A1
(43) Pub. Date: Nov. 3, 2022

(54) Mechanical Device for Regulating Operating Sequence of Parallel Heat Pump Systems

(71) Applicants: Joseph Twaronite, New York, NY (US); David Woltman, Lakewood, NJ (US)

(72) Inventors: Joseph Twaronite, New York, NY (US); David Woltman, Lakewood, NJ (US)

(21) Appl. No.: 17/245,337

(22) Filed: Apr. 30, 2021

(51) Int. Cl. F25B 25/00; F25B 5/02; F25B 30/02

(52) U.S. Cl. CPC F25B 25/00; F25B 5/02; F25B 30/02; F25B 2313/0233; F25B 2313/029; F25B 2600/2507

(57) ABSTRACT

The disclosed invention is a relay switch that is capable of controlling the sequence in which a multi-unit heat pump system where the relay device determines which of the units act as primary and which a secondary. The disclosed switch is capable of reconfiguring the sequencing with a mere flip of a switch or a toggle of an actuator. There is a protective case enclosing the actual switch. The casing carries the dual role of insulating the switch and electrical connectors, as well as providing instructions on how to integrate the disclosed device into an existing heat pump system, as well as how to operate the device after successful integration. The wiring to the switch is accomplished via a panel of clearing marked external connectors. The switch can then operate via a mechanical or electronic actuator exposed on the surface of the protective case, or remotely via a connection module.

### FIELD OF THE INVENTION

The present invention relates to switches intended to automate and streamline routine operating tasks.

### BACKGROUND OF THE INVENTION

Lead-lag systems are often enabled in applications involving multiple boilers. The purpose of a lead-lag system is to maximize the efficiency of a multi-boiler system and prolong the lifespan of the heating units involved. A good example of such environment is a commercial or large property having multiple heat pumps, where a system of relays controls which heat pump is primary, and which is secondary.

A major concern of all lead-lag systems is the simplicity of converting the lead system to be the lag system and visa versa. In sophisticated commercial environments, this problem is resolved using complex system of relays or a dedicated team of human operators that can service the environment and effectively switch systems from lead to lag and back again. On the other hand, in a residential context converting a primary system into a secondary is often a complex manual task that requires rewiring by a skilled technician, making the task both costly and error prone.

Therefore, presently small-scale or manually operated multi-source heat pump environments require manual rewiring and reconfiguration to switch from the sequence of heat pumps. The switching is highly recommended to extend the life of components included in the system. The disclosed device addresses this shortcoming by providing a permanent solution for changing the sequence in which heat pumps come online. The described device also properly marked so that the initial setup, wiring and operation are intuitive and error free.

### SUMMARY OF THE PREFERRED EMBODIMENTS

The disclosed device facilitates the operation of the Lead-Lag heat pump systems comprised of two to four boilers by serving as a switch controlling the sequencing of deployed systems. The description of the disclosed device in the context of an environment comprised of two to four boilers is not intended to be limiting. Those skilled in the art will appreciate that boilers represent any heat pump system, and a configuration of two or four boilers merely describes the most common arrangement of heat pumps where the use of the disclosed device would be highly beneficial. However, a different number and type of heat pumps may be implemented without compromising the utility of the disclosed device.

The disclosed device comprises a switch that controls the priority order of at least two heat pumps. It is preferable that the disclosed switch provides at least three operational settings: a) two settings for dictating the order of Lead/Lag units and reversing the order; and b) a neutral setting which depending on the configuration, enables just the primary heat pump or disables the system completely.

The disclosed device includes a switch configured to accept predetermined electrical connections via electrical ports. The electrical ports are exposed externally within individual niches and are clearly marked to ensure that electrical connections are correctly distributed to ensure proper operation of the system. A mechanical or automatic toggle actuator is then used to control the sequence of operational engagement of primary and secondary units. Like the exposed electric ports, the toggle actuator is clearly marked to ensure that the operator is aware what heat pump sequencing is being implemented at any given time. Since all connections and operational controls are internally pre-wired to clearly marked ports, the possibility of improper or inoperative electrical hookup is greatly reduced.

Once the heat pump units are wired to the disclosed switch; the wiring no longer needs to be redone except to introduce a new or replacement heat pump. The disclosed device may be used to integrate a heterogeneous combination of heat pumps, such as water boiler and air source combination. Since all settings are clearly marked, there is very little chance of making a mistake in enabling a particular sequence, thereby resolving the problem of improperly or incorrectly wiring lead/lag heat pump systems to change sequencing.

Therefore, it is an object of the present invention to provide a device for quickly and easily change sequence of priority of at least two heat pump units in a multi-heat-pump system.

It is another object of the present invention to provide a switch that makes the initial wiring of lead lad sequencing systems simple and errorfree.

It is still another object of the present invention to provide a switch device where operational settings and wire terminal connectivity are clearly marked, severely curtailing the possibility of making a mistake during the setup of a multi-heat-pump system.

### BRIEF DESCRIPTION OF THE DRAWINGS

FIGS. 1 and 2 demonstrates the top of the disclosed device.

FIGS. 3A and 3B demonstrate right and top sides of the disclosed device.

FIGS. 4 and 5 demonstrate left and bottom sides of the disclosed device.

FIG. 6 is a perspective view of the disclosed device.

FIGS. 7 and 8 demonstrates the internal view of the disclosed switch.

FIG. 9 is the schematic of the switch connections.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate, upon reading the present specification and viewing the present drawings, that various modifications and variations can be made thereto.

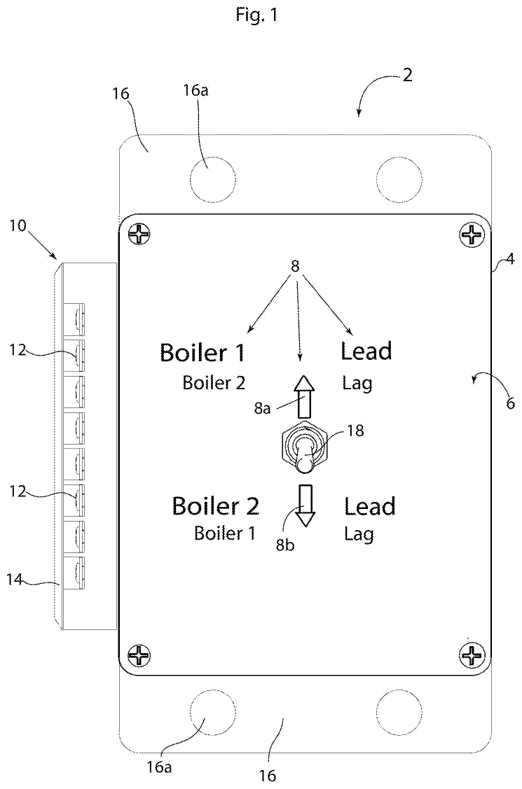

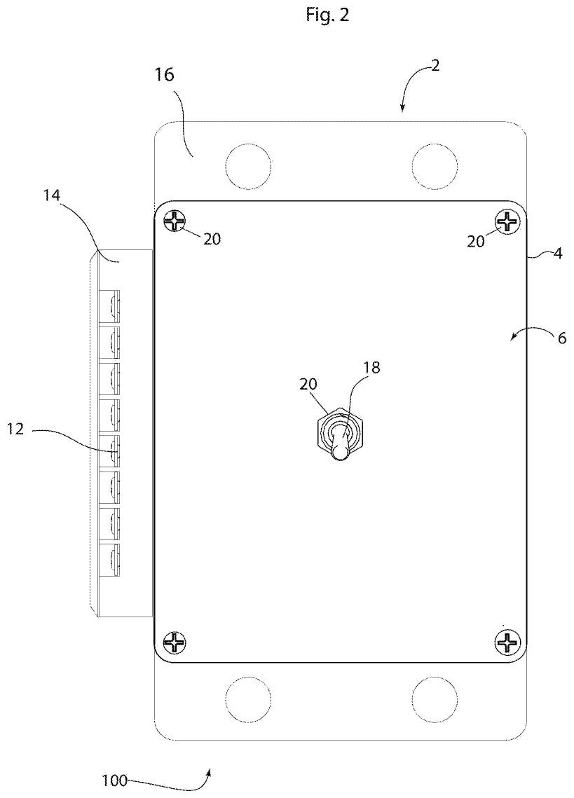

FIGS. 1 and 2 illustrate the disclosed device 2. Visible in these figures is the protective casing 4 having a top surface 6. A plurality of markings 8 describe the operational functionality of the toggle actuator 18. In particular, with an actuator 18 in a downward position 8b as shown, a boiler designated as boiler 2 becomes the lead or primary boiler with the boiler designated as boiler 1 being relegated to the secondary role. Toggling the switch into an upward position 8a causes this lead lag sequence of boilers to be reversed, with boiler 1 serving as lead unit and boiler 2 picking up excess demand for heating or coiling output. The designation of boilers is assigned arbitrarily when the device 2 is wired to the device 2. It should be appreciated that while the disclosed figs refer to the heat pump as being a boiler, other environments are equally compatible with the disclosed device, for example cooling heat pumps, or hybrid heating/cooling heat pumps, such as air exchange systems, water heat pumps or geothermal systems.

A wiring panel 10 is exposed along at least one of the walls of the protective casing 4. The wiring panel 10 is comprised of individually labeled electric connection ports or terminals 12 that are encased within individual niches 12a. The niches 12a compensate for multiple terminals being in close proximity to each other and prevents current leakage and short circuits during wiring installation as well as during the operation of the device 2. A protective cover 14 insulates the niches 12a from each other, as well as prevents users from inadvertent electrical shock when coming into contact to exposed terminal. The wiring panel 10 together with the protective cover 14 may be encased in other forms of temporary and semi-permanent coverings. It is further appreciated that multiple wiring panels 10 may be provided although a single wiring panel may be preferred for more centralized connection management.

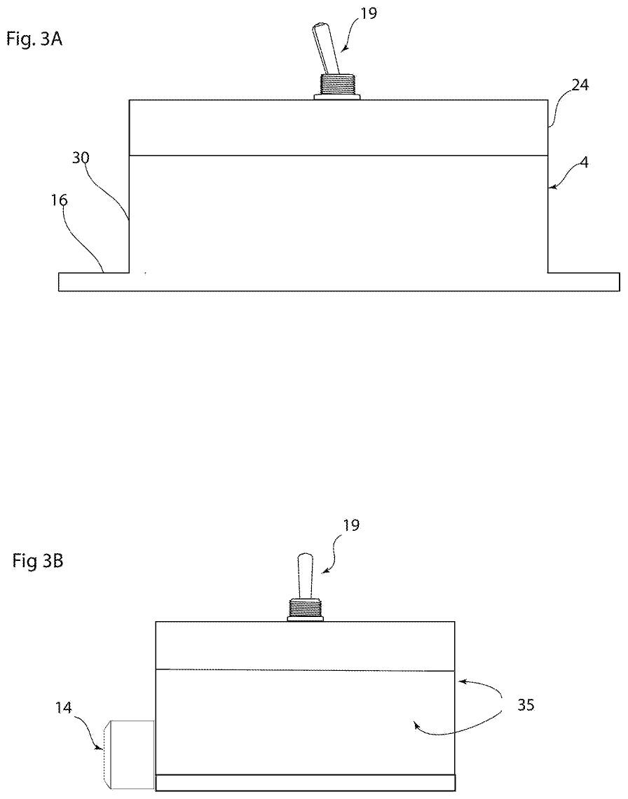

The protective case 4 is mounted onto a back splash 100, a control board, or an existing wall with fasteners that are threaded through fastener openings 16a within shoulder sections 16. The Shoulder sections 16 may exist in various locations around the protective casing 4. The purpose of the shoulder sections 16 is to immobilize the protective casing along a surface of a supporting structure. The disclosed case 4, may contain hooks or loops to enabling installation on studs, suspension hooks or legs for supporting a free-standing device. Alternatively, the fastener openings 16a may be channels running across the width or length of the protective casing 4. Shown in FIGS. 3A and 3B is a protective case 4 having a bottom portion 30 and a top cover 24. A toggle actuator 19 is exposed above the cover 24. It should be appreciated that the toggle actuator 19 may be extended through one of the sidewalls 35. Furthermore, a remotely operated switch or a relay may be used in place of the manually operated toggle actuator 19 that is disclosed throughout the figures.

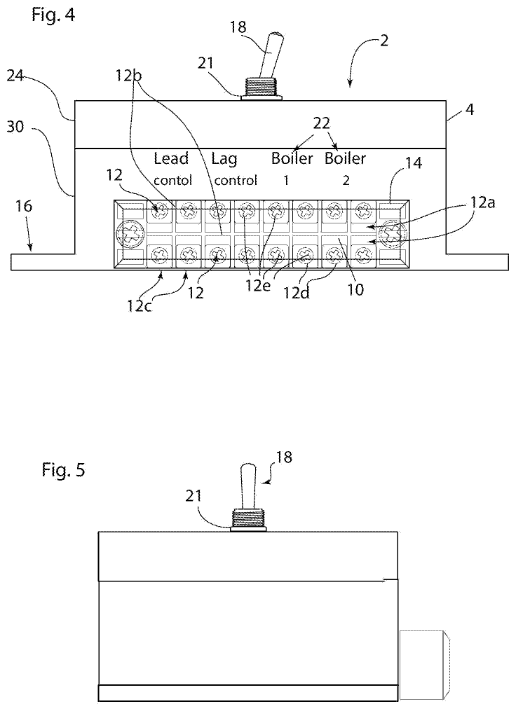

FIGS. 4 and 5 demonstrate the disclosed device 2 from a variety of additional angles. Shown clearly in FIG. 5 is the terminal panel 10 having a plurality of individual terminals 12. Each terminal 12 is housed within its own niche 12a that is separated by barriers 12b from all other niches 12a. Each niche 12a is open to at least one side 12c, which serves as an entry point for a connecting wire. The wire is then retained beneath a connector plate 12d that is held removably in place with a retaining screw 12e. A cover plate 14 shields the terminals 12 is preferable that the cover plate 14, as well as the terminal barriers 12b are made of non-conductive and transparent materials to maintain transparency and visibility of connections at all times, and to satisfy electric safety measures of such connectors. The sidewall housing the terminal panel 10 will also be clearly imprinted with markings 22. The markings 22 are necessary for the initial wiring of the device 2 as well as for labeling of each connection in the event of future troubleshooting. The actuator 18 is retained, on the top cover 24 using a ring nut 21.

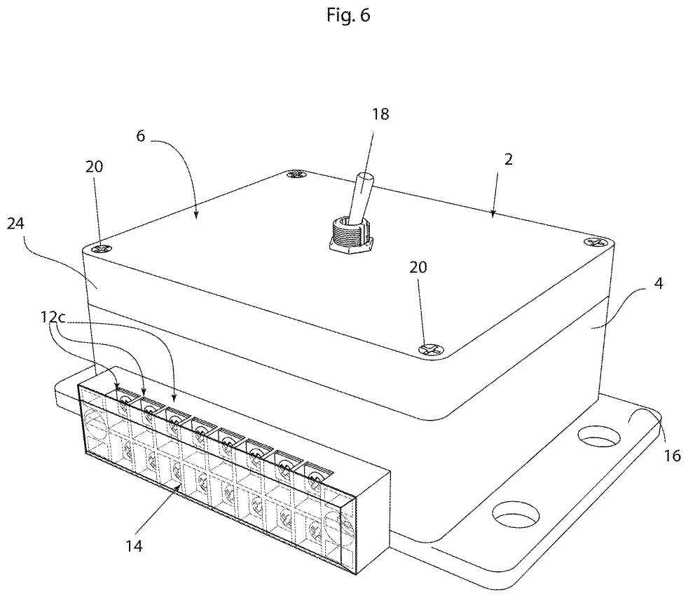

Shown in FIG. 6 a protective casing 4. The cover 24 attaches to the lower portion 30 via fasteners 20. The terminal panel 10 is situated along one of the sidewalls 35. A preferred feature demonstrated in FIG. 6 is the space between the terminal panel 10 and the top surface 6. The separation eliminates the possibility that a user's hand or fingers will come into contact with any wiring accessing the terminals 12. Wiring enters the terminals 12 using open sides 12c. The open sides 12c are located at some distance from the top surface 6 and at a different axial orientation therefrom.

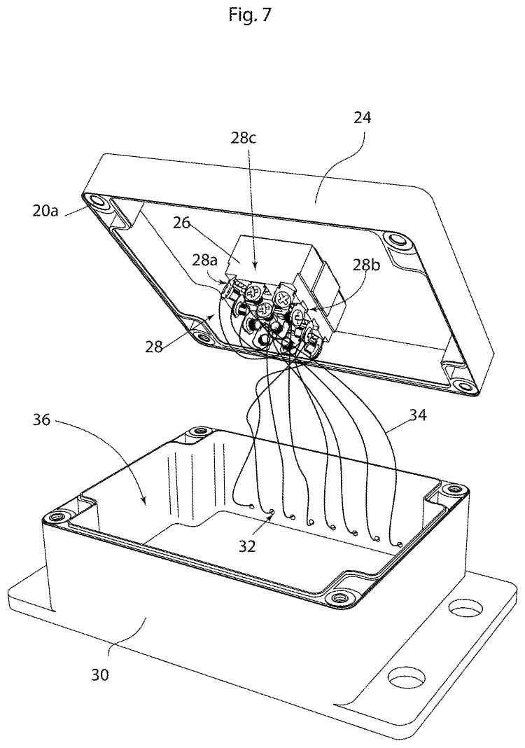

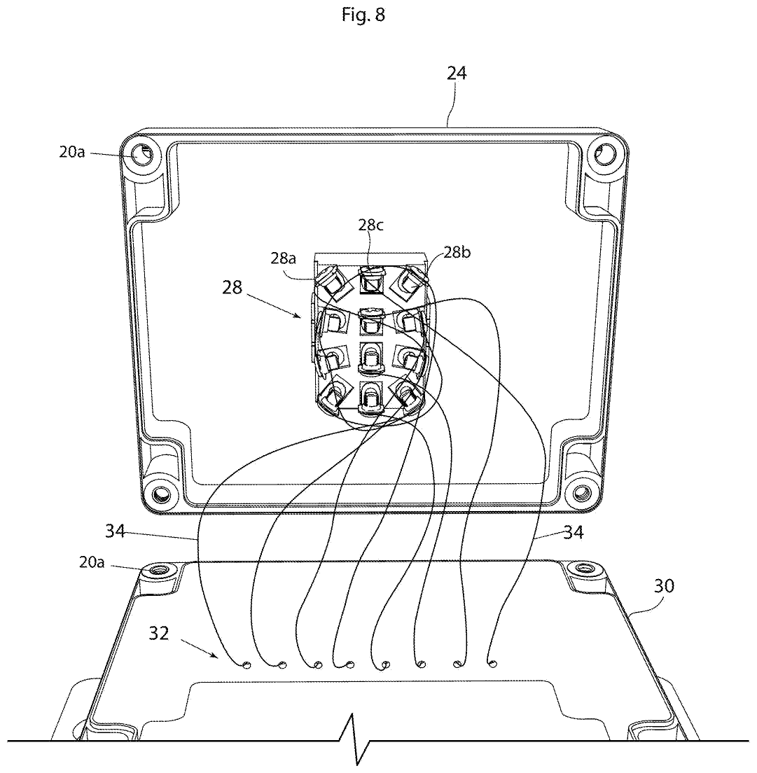

FIGS. 7 and 8 demonstrate the internal components of the disclosed switch 2. Shown in FIGS. 7 and 8 is a dual pole quadruple throw mechanical switch, having exposed terminals 28. Terminals along peripheral rows 28a and 28b except wired connections 34 from heat pump units. The terminals within row 28c represent a neutral or disabled position where the primary unit is always the same, or where the system is turned off. Wiring 34 enters the inner cavity 36 through openings 32 and connects terminals 12 of the terminal panel 10 to the terminal interface 28 of the switch 26. Thus, a user never needs to open the switch device 2, but rather wires the heat pump unites to the terminal panel 10. Fastener openings 20a keep the lid 24 connected to the main portion 30. Alternatively, these may be snap connectors or components are held together through an especially snug fit.

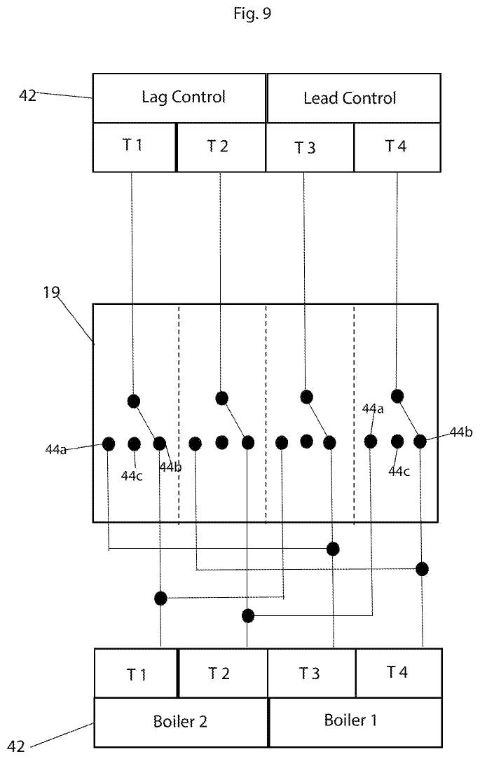

FIG. 9 diagrams the operational layout of the disclosed device. The disclosed switch 19 is connected to the relay terminals 40 and the heat pump terminals 42. The switch can be switched between lead/lag sequence configuration via connectors 44a and 44b or to a neutral setting, via connector 44c. In the neutral setting 44c, the relay is disabled. In the embodiment shown, all heat pump systems are disabled in neutral setting 44c. In alternative embodiments, a neutral setting 44c may disable just the disclosed relay, leaving the heat pump system functioning at some default mode. It should be appreciated that while the switching in the disclosed device 2 occurs manually, the same functionality can be easily adopted to an electrical switching or relay. In the case of an electrical automated switch, a logic or connection modules would be integrated into the device. This module will process remote commands from an external source, such as a computerized relay or switch manager, or execute commands based on an internal paradigm, such as an internal clock, or input received from load sensors on the heat pumps connected thereto.

Although this invention has been described with a certain degree of particularity, it is to be understood that the present disclosure has been made only by way of illustration and that numerous changes in the details of construction and arrangement of parts may be resorted to without departing from the spirit and the scope of the invention.

S

What is claimed:

1. A relay device comprising; a protective casing; said protective casing comprised of sidewalls a bottom wall and top wall; a switch concealed within a cavity formed by said sidewall and said top and bottom walls of said protective casing; an actuator on a surface of said protective casing; a terminal panel containing a plurality of terminals; wherein each terminal in said plurality of terminals is substantially surrounded by a non-conductive barrier; wherein said terminal panel is placed externally along said sidewall; wherein said terminal panel is configured to establish a direct wiring connection between said switch and external wiring connections; and wherein said switch is then configured to control a sequencing of operation of said at least two heat pump units connecting to said terminal panels through said terminal panel.

2. The relay device of claim 2; wherein said protective casing contains pictorial connectivity diagrams configuring to guide said connection and operation of said relay device.

3. The relay device of claim 2; wherein said pictorial connectivity is placed in proximity with one of said plurality of terminals which said pictorial connectivity diagram describes.

4. The relay device of claim 3; wherein said protective casing is divided into a lid and a main portion.

5. The relay device of claim 1; wherein said actuator, is a toggle actuator that is placed at a distance and on separate axis from said terminal panel.

6. The relay device of claim 1; wherein said switch is a quad through dual pole manual switch.

7. The relay device of claim 6, wherein said switch is directly connected to said terminal panel over internal wiring.
